(19) United States
(12) Patent Application Publication
(10) Pub. No.: US 2006/0283075 A1
(43) Pub. Date: Dec. 21, 2006

(54) Insect trap comprising a transparent adhesive film

(75) Inventors: Michael Feldhege, Koblenz (DE); Michael Roreger, Neuwied (DE); Malgorzata Kloczko, Neustadt/Wied (DE)

Correspondence Address: William F Lawrence;FROMMER LAWRENCE & HAUG, 745 Fifth Avenue, New York, NY, 10151, US

(73) Assignee: ECS ENVIRONMENT CARE SYSTEMS GMBH, Andernach (DE)

(21) Appl. No.: 10/555,952

(22) PCT Filed: Apr. 28, 2004
(86) PCT No.: PCT/EP04/04491

§ 371 Date: Nov. 7, 2005

(30) Foreign Application Priority Data
May 8, 2003 (DE) 103 20 488.1

(51) Int. Cl. A01M 1/14

(52) U.S. Cl. 43/114; 43/121

(57) ABSTRACT

The invention relates to an insect trap consisting of a container that surrounds an inner chamber and comprises at least one opening and at least one carrier film provided with an adhesive layer that is accessible from the inner chamber. The carrier film forms a transparent window of the container at least in the vicinity of the adhesive layer. The invention provides a highly effective insect trap, consisting of a small number of different components. The trap is simple to assemble and install and the rate at which it becomes exhausted and needs replacing can be checked visually.

The invention relates to an insect trap consisting of a container which surrounds an inner chamber and comprises at least one opening and at least one carrier film with an adhesive layer which is accessible from the inner chamber.

Such an insect trap is known in the form of a clothes moth adhesive trap from the firm “ARIES Umweltprodukte” in 27367 Horstedt. The trap consists of a box, an adhesive board, and a pheromone dispenser. To assemble the trap, the dispenser is placed centrally on the adhesive board and inserted in such a way into the box provided with a number of openings and fastened in such a way by means of adhesive labels that the adhesive board is oriented toward the box interior. When the sticky adhesive board is inserted, there is a risk of the adhesive board sticking to the container inner wall. The insects to be caught, attracted by the lure, fly or crawl into the box and there arrive on the adhesive film. The adhesive board located in the dark interior of the box can be checked for the degree of exhaustion of the trap only with great difficulty.

The present invention is therefore based on the problem of developing a highly effective insect trap which consists of a small number of different components, is simple to assemble and install, and the degree of exhaustion of which can easily be checked visually.

The problem is solved with the features of the main claim. For this purpose, the carrier film is a transparent window of the container at least in the region of the adhesive layer.

This insect trap consists of a container with at least one opening as an open entrance and at least one opening which is closed by means of a transparent adhesive film, the area of the closed opening as a rule being larger than the sum of the areas of all the open entrances. The container is made of, for example, paperboard, cardboard or a composite material, which is also partly transparent if appropriate. In the illustrative embodiment, the container is parallelepipedal only by way of example. Instead, it may also be cylindrical, semi-cylindrical, prism-shaped or trapezoidal, for example. The adhesive layer of the trap is located on a transparent carrier film, which is covered with a tear-off protective layer before its use.

To use the insect trap for crawling insects such as beetles, woodlice, cockroaches, silverfish, ants etc., and also flying insects such as moths, midges, flies, wasps etc., the adhesive layer is freed from the protective layer and positioned over, for example, one opening of the container by means of the carrier film. In this connection, the adhesive layer faces inward. The insects can enter the container through at least one opening which remains open. They are then, for example when attempting to leave the container through the opening which is covered with the transparent adhesive film, held firmly on it.

The transparent adhesive film makes rapid visual checking of the degree of exhaustion of the adhesive layer possible. For this purpose, the container can simply be held against the light in such a way that the accumulation of caught insects or dust and other dirt particles on the adhesive layer is readily visible. A hanging tab attached to the container additionally broadens the range of application.

A used adhesive film is simply removed and replaced with a new one. The container itself can be used for a relatively long period of time provided it suffers no mechanical damage.

Further details of the invention emerge from the subclaims, which are not or only partly quoted, and the following description of a diagrammatically illustrated embodiment:

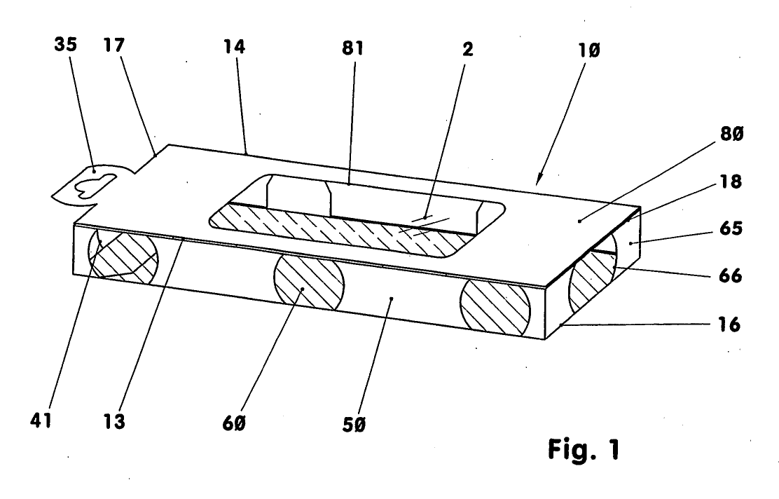

FIG. 1: insect trap in assembled state;

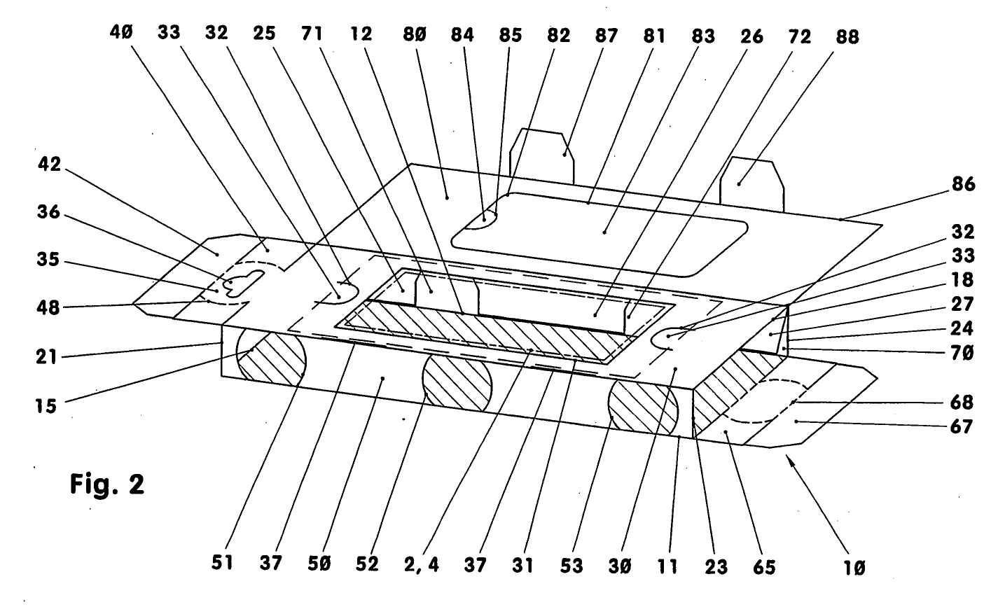

FIG. 2: folding box in open state;

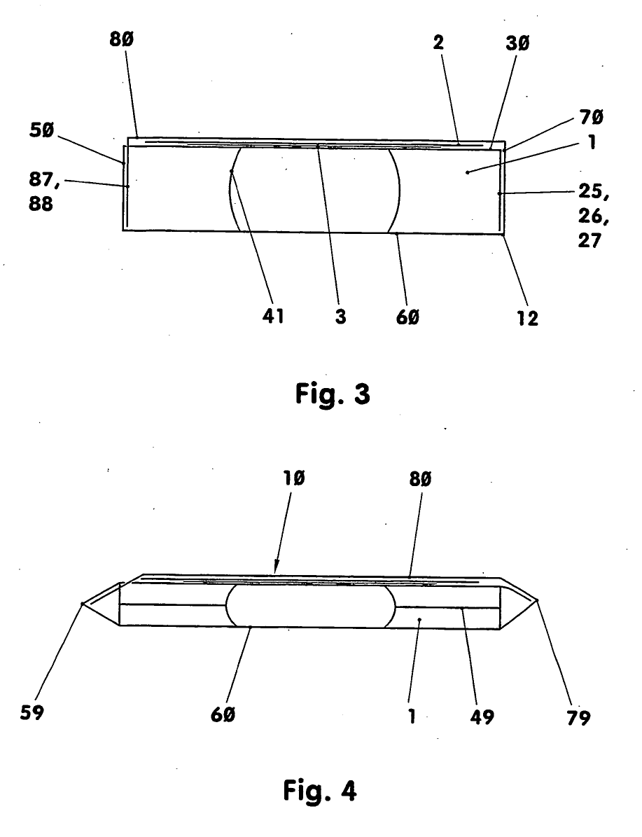

FIG. 3: cross section of the folding box;

FIG. 4: cross section of the folding box with reduced box height.

FIG. 1 shows as a ready-for-use insect trap a closed, parallelepipedal folding box (10) with a window (2) lying behind a lid (70) and a number of openings (41, 51-53, 66, 71-72). The folding box (10), which surrounds an inner chamber (1), has four walls (30, 50, 60, 70), which are connected to form a kind of rectangular tube and are arranged parallel to one another in pairs. The end sides form two flaps (40, 65). The folding box (10) is made from a single, one-piece cardboard blank, the fibers of which are preferably oriented transversely to a lid (80). The cardboard has a grammage of roughly 250 g/m², for example. It is printed at least in areas and if appropriate coated with a transparent lacquer. The maximum height of the folding box (10) is roughly 20 millimeters, for example. The box (10) is, for example, 9.5 times longer and 4.5 times wider than this dimension.

The folding box (10) has a plane, closed bottom (60), which, according to FIG. 2, is adjoined toward the front by a side wall (50) and to the right by an end wall (65). The side walls (50, 65) are separated from the bottom by continuous stamped grooves, the latter forming the outer edges (11) and (16) in the assembled folding box (10).

The side wall (50) has three openings (51-53). Each opening extends between the bottom (60) and a window wall (30) lying opposite the latter. The opening contour of these openings (51-53) corresponds in areas, for example, to a circular area, the diameter of which corresponds to one and a half times the box height. In this connection, the box height is the maximum distance between the bottom (60) and the window wall (30). As the box height is smaller than the circle diameter of the opening contour, the opening lacks a circle segment at both the top and the bottom according to FIGS. 1 and 2, both circle segments being the same size, for example. The centers of the two outer openings (51, 53) are in each case a box height distant from the short outer edges (21, 23), while the center of the central opening (52) lies in the center of the box length.

The right end flap (65), cf. FIG. 2, which is adjoined by an end tab (67), likewise has an opening (66). The latter is part of a circular area, which lacks a circle segment at the top and the bottom. The center of the circular area lies in the geometric center of the end wall (65). The circular area has a diameter which corresponds to 2.25 times the maximum box height, for example. Toward the top and the bottom, the circular area is delimited rectilinearly by the stamped grooves used for folding the end wall (65) and the end tab (67), which grooves form the parallel delimiting lines. The two stamped grooves are outer edges (16, 18) of medium length on the finished folded box (10).

From the perspective of the punched shape development, the side wall (50) is adjoined by the window wall (30), on which the end wall (40) with hanging tab (35) projects on the left side according to FIG. 2. In the center, the window wall (30) has a central rectangular window inner opening (31), which is closed with a press-out lid in the preassembled state, for example. The press-out panel (not illustrated in the figures) is for the most part separated from the window wall (30) by a punched slit. Only a few, very short webs hold the press-out panel in the window wall (30), so that the press-out panel can be removed with a minimum of effort when the insect trap is assembled.

The width of the window wall (30) between the long outer edges (13, 14) and the window inner opening (31) is, for example, 65% of the maximum box height. The window inner opening (31) is twice as long as it is wide, for example.

In the longitudinal direction of the window wall (30), a punched u-shape (32) can be seen on the right and left next to the window inner opening (31). These shapes are located centrally in relation to the transverse direction of the window wall (30) and border gripping tongues (33), which are in each case oriented toward the window inner opening (31).

Two longitudinal slits (37) extending parallel to the outer edge (13) are located in the region of the long outer edge (13), which lies between the window wall (30) and the side wall (50). These longitudinal slits (37) have a width which corresponds at least approximately to the cardboard thickness. The slits (37) are staggered in the longitudinal direction in relation to the side openings (51-53).

According to FIG. 2, the left end flap (40) comprises—at least in the cardboard blank—the hanging tab (35). The latter is surrounded on three sides in the region of the end flap (40) by a punched slit (48) or. perforation. The end flap (40) is delimited from the window wall (30) by two stamped grooves located to the side of the hanging tab (35). The end flap (40) is adjoined by an end tab (42), which is demarcated from the end flap (40) by a further stamped groove. The punched slit (48) for the hanging tab (35) is designed in such a way that the hanging tab (35) does not bend at the window wall (30) when the end flap (40) and the end tab (42) are folded, cf. FIG. 1. A hanging cutout (36) is punched out of the hanging tab (35).

In the region of the outer edge (14), three gluing tabs (25-27) adjoin the window wall (30). The outer sides of the gluing tabs (25-27) are glued together with the inner side of the side wall (70). The side wall (70) is connected in one piece to the bottom (60) at the bottom and to a lid (80) at the top. The long outer edge (12) lies between the walls (60) and (70), cf. FIG. 3. This edge (11) too is prestamped with a stamped groove like the edge (14).

The side wall (70) surrounds congruently with the gluing tabs (25-27), for example, two openings (71, 72). These openings each have an outer contour which corresponds to an insertion tab (87, 88), which tabs are arranged on the free, long outer edge (86) of the lid (80). They are moreover positioned precisely in such a way that they each have a distance to the respective adjacent medium-length outer edge (17) and (18) which is the same as the distance the openings (71, 72) have to the respective adjacent short outer edges (22) and (24). As the gluing tabs (25-27) constitute the beginning and the insertion tabs (87, 88) the end of the plane development of the punched shape of the present folding box (10), the punched shapes can at least in the longitudinal direction be punched out abutting one another and without loss.

The side openings (71, 72) also have a height which corresponds to the maximum height of the inner chamber (1).

The lid (80), rectangular here, of the folding box (10) has a central window opening (81) with, for example, rounded corners (82). The window opening (81), which is roughly twice as long as it is wide, has a distance to each of the long outer edges (13) and (14) which corresponds to 80% of the maximum box height. As long as the folding box (10) is used as a transport container, the window opening (81) is closed by means of a press-out panel (83), cf. FIG. 2. The press-out panel (83) still integrated in the lid (80) is delimited by punched slits arranged along the window opening (81). The short webs located between adjacent punched slits hold the press-out panel (83) in its position. To simplify pressing out of the press-out panel (83), a curved punched slit (85) is located at the right edge of the press-out panel (83), for example. This slit separates a small, circle-segment-shaped auxiliary press-out tab (84).

The contour of the insertion tabs (87, 88) arranged on the free long edge (86) of the lid (80) tapers—measured parallel to the edge—toward their free end. This makes insertion of the insertion tabs (87, 88) into the slits (37) arranged in the window wall (30) easier during assembly of the insect trap.

All the stamped grooves fashioned in the cardboard of the punched shape (1) are located on the smooth cardboard upper side.

The customer purchases the insect trap as a finished folded box (10). The press-out panel (83) and if appropriate the press-out panel integrated in the window wall (30) are as yet unseparated components of the box (10). A stack of windows (2) welded in individually or as a pack is located in the inner chamber (1) of the box (10).

The individual window is a transparent, flexible film (2) with a wall thickness of 0.3 millimeters, for example. The film (2), for example a non-adhesive carrier film, is of just such a length that it can be pushed under the gripping tongues (33) of the window wall (30) without buckling, cf. FIG. 2, where the film (2) is drawn in dashed lines. The film (2) has a width which reaches almost as far as the long outer edges (13) and (14). The film can be single-colored or multi-colored to form specific insect lure patterns. Holographic structures, cf. DE 102 27 947, or mechanically impressed patterns are also conceivable.

The holographic structures are, for example, part of a film-shaped material which is the result of a holographic recording process for representing three-dimensional objects.

An adhesive layer (3) is applied to the underside of the film (2) according to FIG. 2. This adhesive layer (3) has an outer edge (4), which is illustrated in FIG. 2 with a dot-dash line. The outer edge (4) lies a few millimeters inside the window inner opening (31), so that the adhesive layer (3) cannot stick together with the window wall (30) when the film (2) is inserted into the window inner opening (31).

The as a rule transparent adhesive (3) applied to the film (2) can be applied over the surface or part of the surface. When not applied over the entire surface, the adhesive (3) can, for example, be applied in parallel strips, in star-shaped strips, as a dot pattern or as an irregular thread pattern which intersects itself numerous times, cf. DE 101 63 617. The threads forming the various thread patterns are made from an adhesive mass, which has first been given a free-flowing consistency. The mass is applied to a movable substrate, for example the film (2), from a number of outlet nozzles. Conveying the film (2) relative to the outlet nozzles causes the adhesive mass to take on the form of threads.

All kinds of application which give rise to an irregular edge, for example, necessarily have a longer transition zone from the non-adhesive window to the adhesive window area. As a result, more insects can consequently accumulate at the adhesive area edge, avoiding what is known as an edge effect.

The adhesive can also contain at least one active ingredient, for example an insect lure such as attractants or pheromones. Dyes and pigments can also be included in it.

In order to avoid drying out and accidental sticking to the packaging, at least the adhesive surface can be protected with a cover sheet which is coated with a release agent and can be removed again, for example.

According to FIGS. 3 and 4, the window (2) is inserted in the insect trap in such a way that the adhesive layer (3) faces inward. The box (10), which can stand on all the side walls with the exception of the end wall (40), is, as a trap for crawling insects, always aligned in such a way that the lid (80) rests on the surface supporting the box (10). The crawling insects pass through the openings (41, 51-53, 66, 71, 72) into the inner chamber (1). There they come into contact with the adhesive layer (3). If appropriate, the adhesive film (2) can also be arranged on the inner side of the lid (3) instead of on the outer side of the window wall (30).

FIG. 4 illustrates a folding box (10) which has creases extending parallel to the bottom impressed in the side walls (40, 50, 65, 70), for example. Here, these creases are located at half the box height. If the lid (80) is now pressed against the bottom (60) before the adhesive film (2) is inserted, the side walls (40, 50, 65 70) bend outward on account of the creases and the distance between the lid (80) and the bottom (60) is reduced. The container (10) then displays inter alia the bend lines (43, 59, 79) on the outside. Depending on the pressing force applied during deformation of the box (10), the box height can easily be reduced to 3 to 8 millimeters. Insects which mostly inhabit cracks and chinks, such as silverfish or woodlice for example, prefer such low traps, the inner height of which in some cases corresponds to their shoulder heights.

The folding box (10) can be reshaped to its maximum height at any time.

To catch moths which live in cupboards, the folding box (10) is hung on the cupboard inner wall with the hanging tab (35) or is leant against the cupboard inner wall with a side wall (50, 70) on the cupboard compartment bottom.

Flying insects such as houseflies and mayflies or wasps, for example, are caught in daylight in rooms equipped with external windows with an insect trap hung on the window, for example. In this connection, the lid (80) is oriented toward the window, so that the insect, which flies in through one of the openings (41, 51-53, 66, 71, 72), touches in the inner chamber (1) the light-flooded adhesive surface (3) of the carrier film (2) because it attempts to fly through this into the open.

At least one lure device, which emits physical and/or chemical stimuli, can be arranged in the inner chamber (1) of the insect trap. Physical stimuli are optical or acoustic signals, for example, which are emitted permanently or at intervals after the insect trap has been activated. In this regard, the lure device is connected to an electric battery, for example. This battery can be a flat round cell, for example, which is factory-integrated in the edge of the individual carrier film (2) together with the light means or the tone generator and its circuit. The device can then be activated by removal of an insulating strip when the carrier film (2) is installed in the container (10).

If appropriate, the device can also be an electric miniature heating system, which heats at least a small part of the inner chamber (1) by a few degrees or even only a few tenths of a degree to attract certain heat-seeking insects.

### LIST OF REFERENCE NUMBERS

1 inner chamber
2 adhesive film, carrier film, window
3 adhesive layer
4 edge of the adhesive layer
10 container, folding box, box
11, 12 long outer edges, bottom
13, 14 long outer edges, top
15, 16 medium-length outer edges, bottom
17, 18 medium-length outer edges, top
21, 22 short outer edges, left
23, 24 short outer edges, right
25, 26, 27 adhesive tabs
30 window wall
31 window inner opening
32 gripping tongue punched slits
33 gripping tongues
35 hanging tab
36 hanging cutout, Euro hole
37 longitudinal slit for shut (87, 88)
40 end flap, end-wall
41 end opening
42 end tab, insertion tongue
48 punched slit
49 bend line
50 side wall with three openings
51, 52, 53 side openings
59 bend line
60 bottom
65 end flap, end wall
66 end opening
67 end tab, insertion tongue
68 punched slit
70 side wall with two openings
71, 72 side openings
79 bend line
80 lid
81 window opening
82 corners, rounded
83 press-out panel
84 auxiliary press-out tab
85 punched slit
86 edge, long
87, 88 insertion tabs

1. An insect trap consisting of a container (10) which surrounds an inner chamber (1) and comprises at least one opening (41, 51-53, 66, 71, 72) and at least one carrier film (2) with an adhesive layer (3) which is accessible from the inner chamber (1), characterized in that the carrier film (2) is a transparent window of the container (10) at least in the region of the adhesive layer (3).

2. The insect trap as claimed in claim 1, characterized in that the transparent area of the window (2) is larger than the overall area of all the openings (41, 51-53, 66, 71, 72).

3. The insect trap as claimed in claim 1, characterized in that the transparent area of the window (2) is, in a container (10) with openings of different size, at least six times larger than the overall area of the largest opening (41, 66).

4. The insect trap as claimed in claim 1, characterized in that the transparent area of the window (2) is, in a container (10) with openings of different size, at least ten times larger than the overall area of the smallest opening (71, 72).

5. The insect trap as claimed in claim 1, characterized in that the transparent area of the window (2) corresponds to at least 15% of the overall area of the container walls (30, 40, 50, 60, 65, 70) including the openings (41, 51-53, 66, 71, 72).

6. The insect trap as claimed in claim 1, characterized in that the container (10) is a parallelepipedal or cuboid closable folding box with attached side flaps (40, 65), at least one of the large side walls (30, 60) having a window inner opening (31) which can be closed by means of a transparent adhesive film (2).

7. The insect trap as claimed in claim 6, characterized in that a lid (80), which has a window opening (81) which lies in front of the window inner opening (31), is arranged in front of the large side wall (30) which has a window inner opening (31), the window inner opening (81) and the window opening (31) holding the adhesive film (2) in a frame-like way.

8. The insect trap as claimed in claim 1, characterized in that the adhesive layer (3) applied to the transparent adhesive film (2) is oriented toward the inner chamber (1) of the container (10) and has an outer edge (4) which does not reach as far as the window inner opening (31).

9. The insect trap as claimed in claim 1, characterized in that at least two gripping elements (33) are arranged in the wall (30) supporting the adhesive film (2) for positioning, releasable fixing of the adhesive film (2).

10. The insect trap as claimed in claim 1, characterized in that the adhesive (3) is not applied to the adhesive film (2) over the entire surface within the edge (4).

11. The insect trap as claimed in claim 1, characterized in that the adhesive (3) contains an active ingredient acting as an insect lure.

12. The insect trap as claimed in claim 1, characterized in that at least one lure device, which emits optical, thermal, acoustic and/or chemical stimuli, is arranged in the inner chamber (1).

13. The insect trap as claimed in claim 12, characterized in that the lure device is operated by means of external electrical or chemical energy.
